(19) United States
(12) Patent Application Publication
(10) Pub. No.: US 2026/0025454 A1
(43) Pub. Date: Jan. 22, 2026

(54) PAIRED ALIAS EQUIPMENT (AE) WITH CALL CAPABILITY

(71) Applicant: T-Mobile USA, Inc., Bellevue, WA (US)

(72) Inventors: Jagannadha Anudeep Varma DATLA, Kent, WA (US); Harikishore ALLU BALAN, Lynnwood, WA (US)

(21) Appl. No.: 18/776,244

(22) Filed: Jul. 17, 2024

(51) Int. Cl. H04M 1/60; H04M 3/42; H04W 60/04

(52) U.S. Cl. CPC H04M 1/6091; H04M 3/42059; H04W 60/04

(57) ABSTRACT

Solutions are disclosed that provide call capability for an alias equipment (AE) having a subscriber identity module (SIM) that is paired with a SIM of a user equipment (UE). An AE may be a combination of an in-car WiFi hotspot, vehicle tracker, and diagnostic code reader that uses a cellular connection to provide smart connectivity for an automobile. When the automobile is operational (i.e., running), the AE registers with a wireless network (e.g., cellular network). If the UE is currently registered, the AE is registered for data only (i.e., no voice), whereas, if the UE is not currently registered, the AE is registered for both voice and data. A voice and data registration permits the AE to make and receive calls. If the user misplaces the UE, the AE may be temporarily moved to a voice and data registration to alert contacts that the UE is missing.

### BACKGROUND

An alias equipment (AE) may be a combination of an in-car WiFi hotspot, vehicle tracker, and diagnostic code reader (e.g., coupled to an on-board diagnostics port) that uses a cellular connection to provide smart connectivity for an automobile. An AE may either be built into a vehicle, or may be provided as an after-market product. To use a cellular connection, the AE requires a subscriber identity module (SIM) that is associated with a cellular user account. When the owner of the AE has a cellular user account that is associated with a user equipment (UE), the AE and the UE may be associated with the same user account.

Because UEs are often used for voice, the SIMs in UEs are voice capable. However, because AEs have a data-only role (i.e., internet connectivity for UEs using the in-vehicle WiFi, and data from vehicle tracking and diagnostic code reading functions) SIMs in AEs are data-only capable, and not voice capable. While this may be acceptable when a user (e.g., a cellular user account holder) is in possession of the UE, if the UE is misplaced or stolen, the user may become frustrated that the user has another device with a SIM (i.e., the AE), but cannot make any voice calls with it.

### SUMMARY

The following summary is provided to illustrate examples disclosed herein, but is not meant to limit all examples to any particular configuration or sequence of operations.

Solutions are disclosed that provide call capability for paired alias equipment (AE). Examples pair a first subscriber identity module (SIM) in a user equipment (UE) with a second SIM in an alias equipment (AE), the AE communicatively coupled to a vehicle; based on at least the vehicle becoming operational, attempt, by the AE, to register with a wireless network; determine, by the wireless network, that the UE is not currently registered with the wireless network; based on at least determining that the UE is not currently registered with the wireless network, register the AE for a voice and data network connection; and initiate, a mobile originating (MO) voice call using the AE, using a phone number of the UE for outgoing caller ID.

Additional examples pair a first SIM in a UE with a second SIM in an AE, the AE communicatively coupled to a vehicle; while the AE has a data only network connection, receive, by the wireless network, a mobile terminating (MT) voice call for the UE; determine, by the wireless network, whether the UE is currently registered with the wireless network; based on at least determining that the UE is not currently registered with the wireless network, register the AE for a voice and data network connection; and either: route the MT voice call to both the UE and the AE as a forked call; based on the UE answering the MT voice call, terminate signaling of the MT voice call to the AE; and based on the AE answering the MT voice call, terminate signaling of the MT voice call to the UE; or: route the MT voice call to both the UE and the AE as a multi-party call; answer the MT voice call by the UE; and answer the MT voice call by the AE.

### BRIEF DESCRIPTION OF THE DRAWINGS

The disclosed examples are described below with reference to the accompanying drawing figures listed below, wherein:

FIG. 1 illustrates an exemplary architecture that advantageously provides call capability an alias equipment (AE) having a subscriber identity module (SIM) that is paired with a SIM of a user equipment (UE);

FIG. 2 illustrates further detail for the AE of FIG. 1;

FIG. 3 illustrates further detail for exemplary data sets used in examples of the architecture of FIG. 1;

FIGS. 4A, 4B, and 4C illustrate exemplary message sequence diagrams of messages that may be used in examples of the architecture of FIG. 1;

FIGS. 5, 6, 7, 8, and 9 illustrate flowcharts of exemplary operations associated with the architecture of FIG. 1; and

FIG. 10 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that provide call capability for an alias equipment (AE) having a subscriber identity module (SIM) that is paired with a SIM of a user equipment (UE). An AE may be a combination of an in-car WiFi hotspot, vehicle tracker, and diagnostic code reader that uses a cellular connection to provide smart connectivity for an automobile. When the automobile is operational (i.e., running), the AE registers with a wireless network (e.g., cellular network). If the UE is currently registered, the AE is registered for data only (i.e., no voice), whereas, if the UE is not currently registered, the AE is registered for both voice and data. A voice and data registration permits the AE to make and receive calls using the vehicle's phone interface (i.e., microphone and speaker).

If the user misplaces the UE, the AE may be temporarily moved to a voice and data registration to alert contacts that the UE is missing. Additionally, when a call is incoming, some examples check for whether the UE is currently registered and, if not, temporarily move the AE to a voice and data registration to receive the incoming call.

Aspects of the disclosure improve the utility of network authentication by enabling an AE to both make outgoing (mobile originating, MO) voice calls and receive incoming (mobile terminating, MT) voice calls when a UE is misplaced, stolen, or turned off (or otherwise not registered with the wireless network). These advantageous results are accomplished, at least in part, by based on at least determining that the UE is not currently registered with the wireless network, registering the AE for a voice and data network connection, and/or based on at least performing the voice connectivity authorization process, registering the AE for a voice and data network connection.

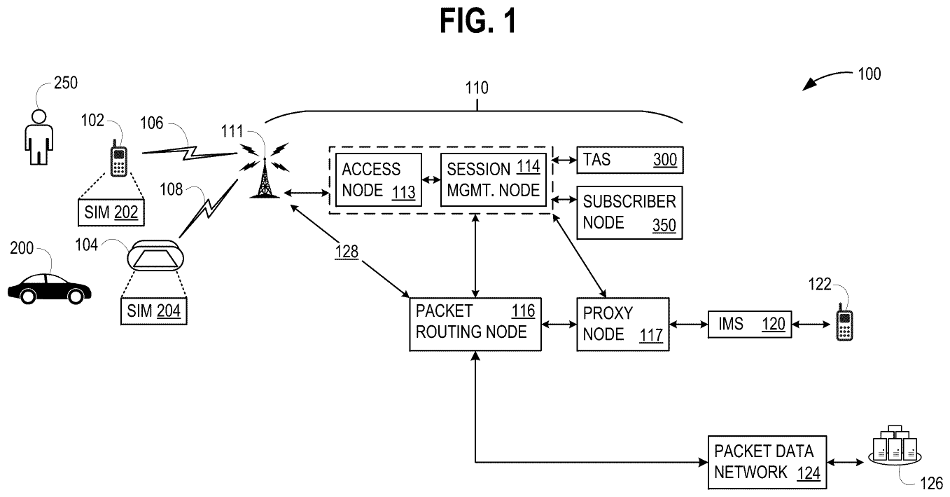

With reference now to the figures, FIG. 1 illustrates an exemplary architecture 100 that advantageously provides call capability for an AE 104 having a SIM 204 that is paired with a SIM 202 of a UE 102. SIM 202 and SIM 204 are each voice capable, and may each comprise a physical SIM (pSIM) or an embedded SIM (eSIM).

A wireless network 110 is illustrated that is serving UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 106 to communicate with a base station 111 of wireless network 110, such that base station 111 is the serving base station for UE 102 (providing the serving cell). Similarly, AE 104 uses an air interface 108 to communicate with base station 111, such that base station 111 is the serving base station for AE 104. In some scenarios, base station 111 may be referred to as a radio access network (RAN). Wireless network 110 has an access node 113, a session management node 114, a telephone application server (TAS) 300, a subscriber node 350, and other components (not shown). Wireless network 110 also has a packet routing node 116 and a proxy node 117. Access node 113, session management node 114, TAS 300, and subscriber node 350 are within a control plane of wireless network 110, and packet routing node 116 is within a data plane (a.k.a. user plane) of wireless network 110.

Base station 111 is in communication with access node 113 and packet routing node 116. Access node 113 is in communication with session management node 114, which is in communication with packet routing node 116, proxy node 117, TAS 300, and subscriber node 350. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), subscriber node 350 comprises a unified data management (UDM), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), subscriber node 350 comprises a home subscriber server (HSS), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) 120, which access gateway (IMS-AGW) in order to provide connectivity to other wireless (cellular) networks, such as for a call with a UE 122 or a public switched telephone system (PSTN, also known as plain old telephone system, POTS). In some examples, proxy node 117 and/or TAS 300 may be considered to be within IMS 120. UE 102 reaches network resource 126 using packet data network 124 (or IMS 120, in some examples). Data packets of data traffic 128 to/from UE 102 pass through at least base station 111 and packet routing node 116 on their way from/to packet data network 124 or IMS 120 (via proxy node 117).

As illustrated in further detail in FIGS. 2-10, and described more fully below in relation to the other figures, TAS 300 and subscriber node 350 contain data and logic to enable an account holder 250 (e.g. the “user”) to engage in MO and MT voice calls over wireless network 110 using AE 104, in various scenarios. As used herein, voice calls may encompass video calls. In some examples, AE 104 may have a form factor for plugging into an on-board diagnostics (OBD) port of vehicle 200, or may have another form factor.

Although FIG. 1 and some of the following figures are described using an example of a cellular network, it should be understood that the teachings herein are applicable to other types of wireless networks. To benefit from the teachings herein, another wireless network, other than a cellular network, should manages accounts for its customers that are tied so identifying components, such as SIMs, that may be logically paired in some customer database. With such features, another type of wireless network, other than a cellular network, may also benefit from the disclosure herein.

FIG. 2 illustrates account holder 250 in vehicle 200 with UE 102, having SIM 202. AE 104 is shown with SIM 204, and is installed in (or otherwise coupled to) vehicle 200. In some examples, may have a form factor that provides for AE 104 to have its own touchscreen 210, keypad 212, microphone 214, and/or speaker 216. In some examples, AE 104 is a small device that plugs into the OBD port of vehicle 200 and leverages a touchscreen 220 with a keypad 222 (e.g., a virtual or soft keypad), a microphone 224, and a speaker 226 of vehicle 200. For example many automobiles (examples of vehicle 200) have microphone and speaker that may be used with a UE (e.g., UE 102) for voice calls using Bluetooth™, and a touchscreen that permits user entry of things such as music selection and navigation instructions.

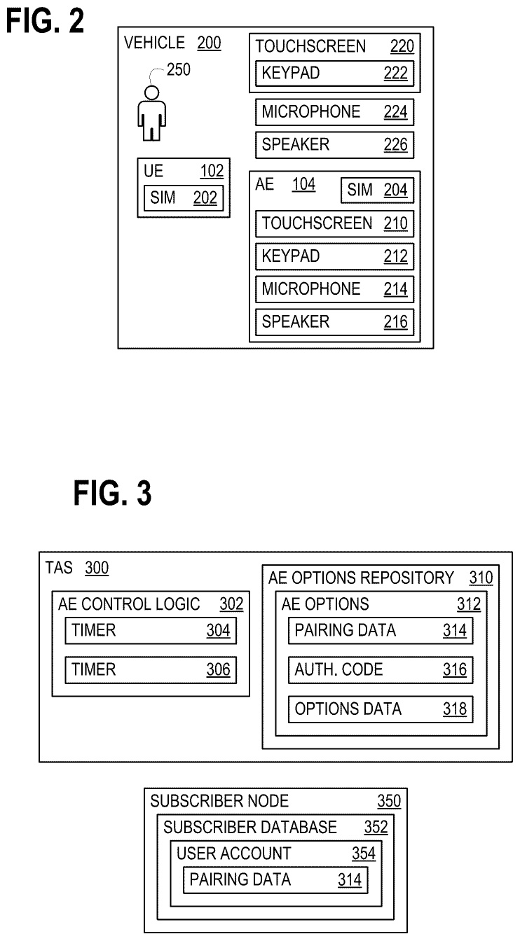

FIG. 3 illustrates further detail for TAS 300 and subscriber node 350. TAS 300 has AE control logic 302 and an AE options repository 310 (a wireless network AE options repository). AE control logic 302 has two timers, a timer 304 and a timer 306. As described below, timer 304 is used to trigger deregistering AE 104 from a voice and data network connection, reverting to a data only network connection that does not include voice capability. Timer 306 is used to trigger deregistering AE 104 from wireless network 110, whether a voice and data network connection, or a data only network connection.

AE options repository 310 has an AE options data set 312, for example, one for each AE associated with a user account of wireless network 110. AE options data set 312 has pairing data 314 that identifies SIM 202 and SIM 204 as paired, an authorization code 316, and options data 318 that identifies whether AE 104 is permitted to accept MO voice calls and receive MT voice calls. In the scenarios described herein, options data 318 indicates that AE 104 is permitted to accept MO voice calls and receive MT voice call, although in some scenarios, account holder 250 may turn these options off.

Authorization code 316 is used as a way to check whether account holder 250 really does want to move AE 104 from a data only network connection to a voice and data network connection, and there has not been an accidental touchscreen press or an unauthorized attempt by another person to change the registration of AE 104. Authorization code 316 may be an unstructured supplementary service data (USSD) personal identification number (PIN), such as the PIN used for retrieving voicemail from wireless network 110, or a voicemail password.

In some examples, AE control logic 302 and/or AE options repository 310 may be located elsewhere in wireless network 110, including being distributed among multiple nodes. Subscriber node 350 has a subscriber database 352 holds a user account 354 indicating the cellular services provided to account holder 250, and which also may have a copy of pairing data 314.

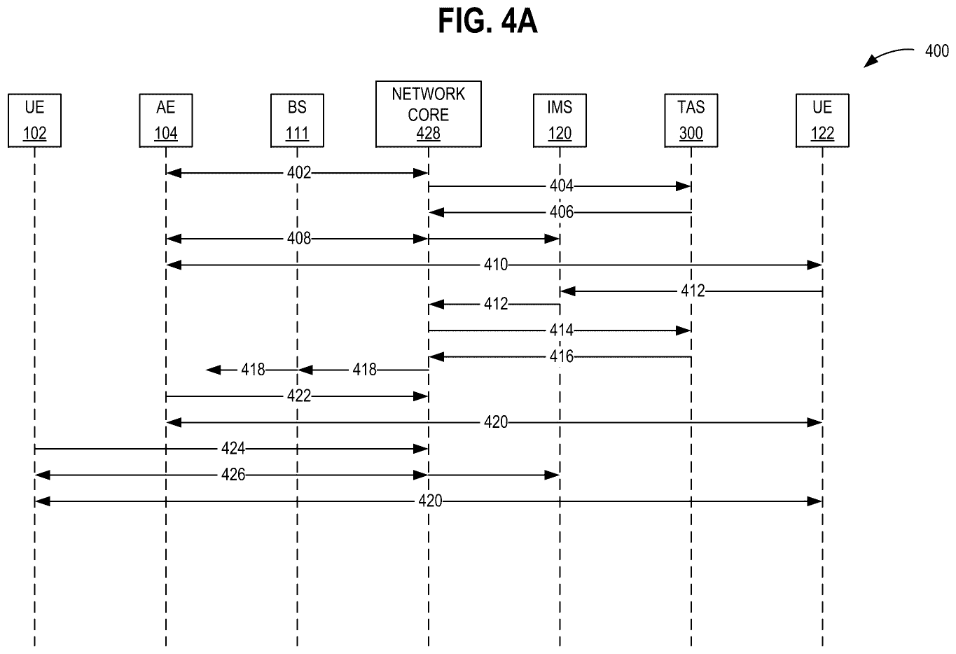

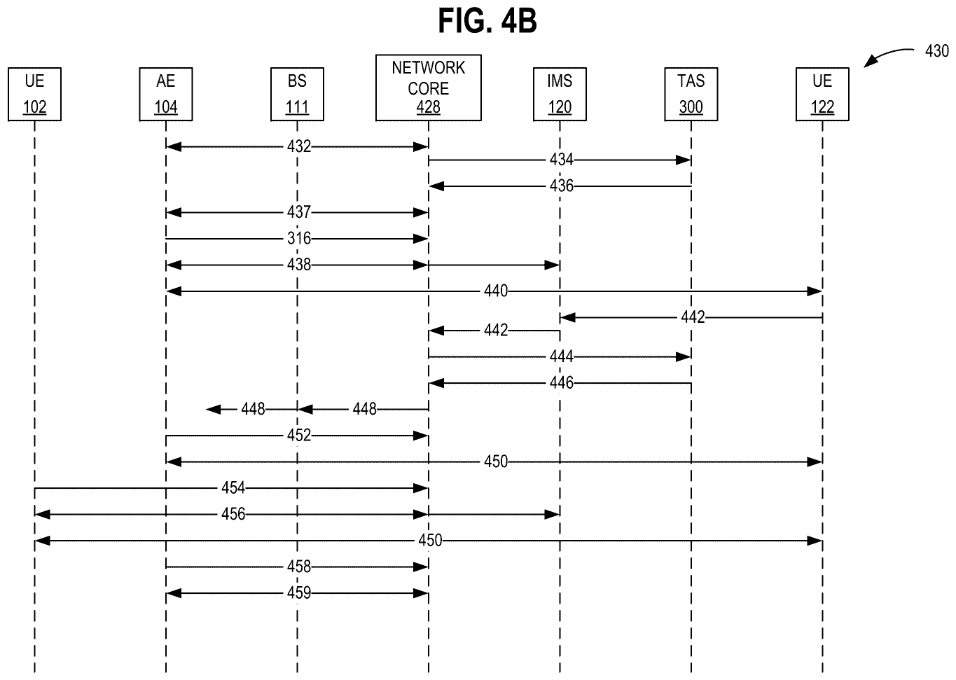

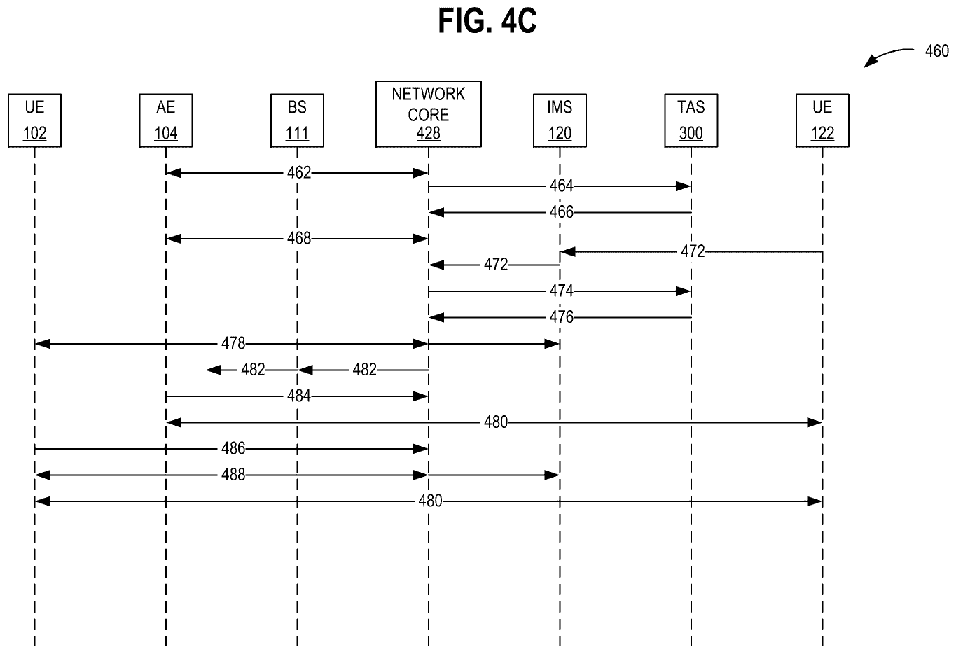

FIGS. 4A, 4B, and 4C illustrate exemplary message sequence diagrams 400, 430, and 460 respectively, of messages that may be used in examples of architecture 100. In message sequence diagram 400 of FIG. 4A, AE 104 attempts to register with wireless network 110 using messages 402. A network core 428, that includes at least session management node 114, queries AE control logic 302 in TAS 300, using message 404, to determine whether a UE that is associated with AE 104 is currently registered. As used herein, currently registered means that the UE has had an active registration with wireless network 110 during a preceding defined time period, such as five minutes.

AE control logic 302 queries AE options repository 310 and determines that UE 102 is paired with AE 104, because SIM 202 is paired with SIM 204. AE control logic 302 then determines whether UE 102 is currently registered with wireless network 110, which in this scenario UE 102 is not currently registered. AE control logic 302 (in TAS 300, in this scenario) responds to network core 428 that UE 102 is not currently registered with wireless network 110, using message 406. So, AE 104 is registered with wireless network 110 for a voice and data network connection using messages 408, which includes registering AE 104 with IMS 120.

Using the voice and data network registration, AE 104 initiates an MO voice call 410. Afterward, an external caller, using UE 122, initiates an MT voice call 420 (shown as being completed later), using signaling 412. Signaling 412 first reaches IMS 120, then network core 428. Network core 428 queries AE control logic 302, using message 414, to determine whether UE 102 has become currently registered. In this scenario UE 102 is still not currently registered. AE control logic 302 responds to network core 428 that UE 102 is not currently registered with wireless network 110, using message 416. Network core 428 sends out paging 418, for MT voice call 420, to both UE 102 and AE 104.

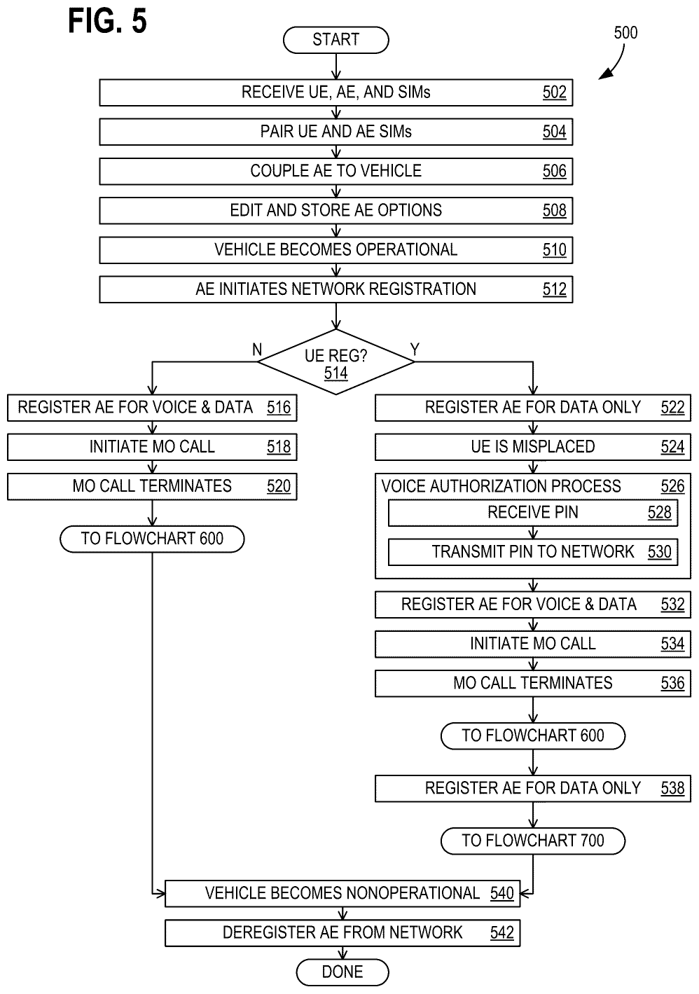

In one scenario, AE 104 responds to paging 418 with a message 422, and MT voice call 420 is established between AE 104 and UE 122. In another scenario, UE 102 responds to paging 418 with a message 424, registers with wireless network 110 using messages 426, and MT voice call 420 is established between UE 102 and UE 122. Various messages of message sequence diagram 400 will be referenced again in the description of FIG. 5.

In message sequence diagram 430 of FIG. 4B, AE 104 attempts to register with wireless network 110 using messages 432. Network core 428 queries AE control logic 302 using message 434, to determine whether a UE that is associated with AE 104 is currently registered. AE control logic 302 queries AE options repository 310 and determines that UE 102 is paired with AE 104, and then determines whether UE 102 is currently registered with wireless network 110. AE control logic 302 responds to network core 428 that UE 102 is currently registered with wireless network 110 (in this scenario), using message 436. So, AE 104 is registered with wireless network 110 for a data only network connection (not including voice capability) using messages 437. AE 104 is not registered with IMS 120 at this time.

Account holder 250 misplaces UE 102 and wishes to make an MO voice call using AE 104. By account holder 250 entering authorization code 316, and AE 104 transmitting authorization code 316 to network core 428, AE 104 is then registered with wireless network 110 for a voice and data network connection using messages 438, which includes registering AE 104 with IMS 120. Using the voice and data network registration, AE 104 initiates an MO voice call 440. Afterward, an external caller, using UE 122, initiates an MT voice call 450 (shown as being completed later), using signaling 442. Signaling 442 first reaches IMS 120, then network core 428. Network core 428 queries AE control logic 302, using message 444, to determine whether UE 102 has become currently registered. In this scenario UE 102 is still not currently registered. AE control logic 302 responds to network core 428 that UE 102 is not currently registered with wireless network 110, using message 446. Network core 428 sends out paging 448, for MT voice call 420, to both UE 102 and AE 104.

In one scenario, AE 104 responds to paging 448 with a message 452, and MT voice call 450 is established between AE 104 and UE 122. In another scenario, UE 102 responds to paging 448 with a message 454, registers with wireless network 110 using messages 456, and MT voice call 450 is established between UE 102 and UE 122. Because UE 102 is now located (and retrieved), AE 104 transmits a request 458 to wireless network 110 to return to being registered with the wireless network for a data only network connection. This is accomplished using messages 459. Various messages of message sequence diagram 430 will be referenced again in the description of FIG. 5.

In message sequence diagram 460 of FIG. 4C, AE 104 attempts to register with wireless network 110 using messages 462. Network core 428 queries AE control logic 302 using message 464, to determine whether a UE that is associated with AE 104 is currently registered. AE control logic 302 queries AE options repository 310 and determines that UE 102 is paired with AE 104, and then determines whether UE 102 is currently registered with wireless network 110. AE control logic 302 responds to network core 428 that UE 102 is currently registered with wireless network 110 (in this scenario), using message 466. So, AE 104 is registered with wireless network 110 for a data only network connection using messages 437.

An external caller, using UE 122, initiates an MT voice call 480 (shown as being completed later), using signaling 472. Signaling 472 first reaches IMS 120, then network core 428. Network core 428 queries AE control logic 302, using message 474, to determine whether UE 102 has become currently registered. In this scenario UE 102 is still not currently registered. AE control logic 302 responds to network core 428 that UE 102 is not currently registered with wireless network 110, using message 476. So, network core 428 upgrades the registration of AE 104 to a voice and data network connection using messages 478, which includes registering AE 104 with IMS 120. Network core 428 sends out paging 482, for MT voice call 420, to both UE 102 and AE 104.

In one scenario, AE 104 responds to paging 482 with a message 484, and MT voice call 450 is established between AE 104 and UE 122. In another scenario, UE 102 responds to paging 482 with a message 486, registers with wireless network 110 using messages 488, and MT voice call 450 is established between UE 102 and UE 122. Various messages of message sequence diagram 460 will be referenced again in the description of FIG. 5.

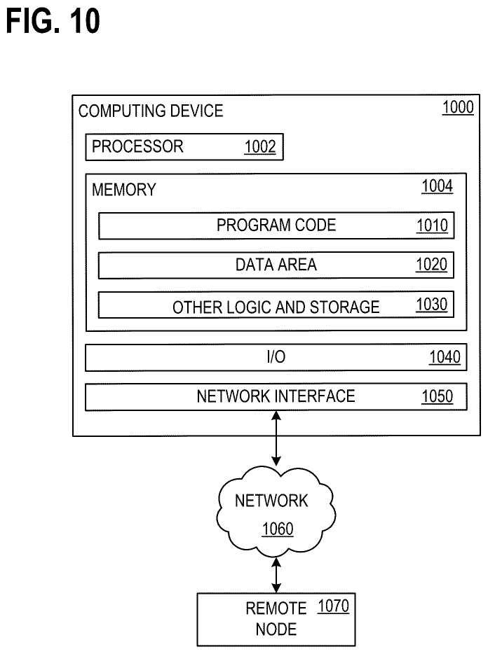

FIG. 5 illustrates a flowchart 500 of exemplary operations associated with usage of AE 104, as described above. In some examples, at least a portion of flowchart 500 may be performed using one or more computing devices 1000 of FIG. 10. Flowchart 500 commences with account holder 250 receiving UE 102 with SIM 202 and AE 104 with SIM 204, in operation 502. Account holder 250 may be anyone authorized to possess UE 102 and AE 104. SIM 202 and SIM 204 are each associated with user account 354 of account holder 250, are each voice capable, and may each comprise a pSIM or an eSIM.;

SIM 202 in UE 102 is paired with SIM 204 in AE 104 in operation 504, and AE 104 is communicatively coupled to vehicle 200 in operation 506. AE 104 either has microphone 214 and speaker 216 for voice calls or is communicatively coupled to microphone 224 and speaker 226 of vehicle 200. AE 104 either has keypad 212 or touchscreen 210 for data entry, or is communicatively coupled to touchscreen 220 of vehicle 200 (which has a virtual keypad 222).

In operation 508, account holder 250 edits AE options data set 312 in AE options repository 310, which identifies authorization code 316, whether MO voice calls from AE 104 are permitted, and whether routing MT voice calls to AE 104 is permitted.

Vehicle 200 becomes operational (e.g., by being turned on or started up) in operation 510. Based on at least vehicle 200 becoming operational, AE 104 attempts to register with wireless network 110 in operation 512. See messages 402, 432, and 462 in message sequence diagrams 400, 430, and 460, respectively. In decision operation 514, based on at least AE 104 attempting to register, wireless network 110 determines whether UE 102 is currently registered with wireless network 110. See messages 404, 434, and 464 in message sequence diagrams 400, 430, and 460, respectively. In some examples, decision operation 514 determines whether UE 102 has had an active registration with wireless network 110 during a preceding defined time period, such as five minutes.

If wireless network 110 determines that UE 102 is not currently registered (in decision operation 514), operation 516 registers AE 104 for a voice and data network connection. See messages 408 in message sequence diagram 400. Registering AE 104 for a voice and data network connection comprises registering AE 104 for IMS connectivity with IMS 120. MO voice call 410 (message sequence diagram 400) is initiated in operation 518, and uses the phone number of UE 102 for outgoing caller ID in some examples. MO voice call 410 terminates in operation 520. Any of the MO voice calls shown in message sequence diagrams 400, 430, and 460 may include video, in some examples.

Flowchart 500 then invokes flowchart 600 for MT voice call 420, as described below. Upon return from flowchart 600, vehicle 200 becomes non-operational (i.e., is turned off) in operation 540. Based on at least vehicle 200 becoming non-operational, AE 104 deregisters from wireless network 110, in operation 542. AE 104 deregistering from wireless network 110 includes deregistering from IMS 120 (if AE 104 had been registered for a voice and data network connection). In some examples, AE 104 initiates AE 104 deregistering from wireless network 110, whereas in some examples, wireless network 110 initiates AE 104 deregistering from wireless network 110 based on at least lapse of timer 306. Timer 306 may measure the time interval from when wireless network 110 last received any messages from AE 104. Flowchart 500 then ends.

However, if in decision operation 514, wireless network 110 determines that UE 102 is currently registered, operation 522 registers AE 104 for a data only network connection that does not include voice capability. Registering AE 104 for a data only network connection results in not registering AE 104 for IMS connectivity. See messages 437 and 468 of message sequence diagrams 430 and 460, respectively.

Account holder 250 is unable to locate UE 102 (shown as operation 524), for example by misplacing UE 102. At this time, in this example, UE 102 is currently registered with wireless network 110. Account holder 250 performs a voice connectivity authorization process for AE 104 in operation 526, which is performed using operations 528 and 530. In operation 528, account holder 250 enters authorization code 316 into AE 104, for example using keypad 212 of AE 104, touchscreen 210 of AE 104, keypad 222 of vehicle 200, or touchscreen 220 of vehicle 200. AE 104 transmits authorization code 316 is provided to AE control logic 302 in operation 530, using wireless network 110.

Based on at least the voice connectivity authorization process (operation 526) having been performed, operation 532 registers AE 104 for a voice and data network connection using messages 438 of message sequence diagram 430. MO voice call 440 (message sequence diagram 430) is initiated in operation 534, and uses the phone number of UE 102 for outgoing caller ID in some examples. MO voice call 440 terminates in operation 536.

Flowchart 500 then invokes flowchart 600 for MT voice call 450, as described below. Upon return from flowchart 600, AE 104 moves to being registered for a data only network connection, using messages 459 of message sequence diagram 430, in operation 538. In some examples, account holder 250 initiates a request 458 shown in message sequence diagram 430, such as using a touchscreen or voice control (which may be substituted for any keypad or touchscreen input, in some examples). In some examples, the lapse of timer 304 initiates request 458 (if timer 304 is in AE 104), or timer 304 is in wireless network 110, and wireless network 110 initiates moving registration of AE 104 to a data only network connection upon the lapse of timer 304.

In any of these scenarios, AE 104 returns to being registered with wireless network 110 for a data only network connection, which includes deregistering AE 104 from IMS 120. Flowchart 500 then invokes flowchart 700 for MT voice call 480, as described below. Upon return from flowchart 700, flowchart 500 moves to operation 540, which was described above.

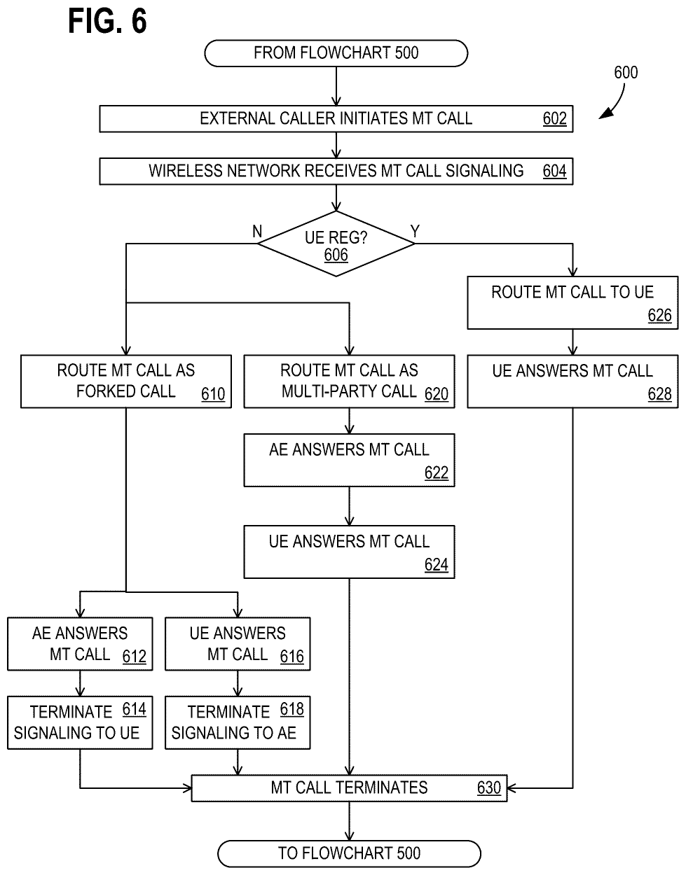

FIG. 6 illustrates a flowchart 600 of exemplary operations associated with receiving an MT call when AE 104 has a voice and data network connection. In some examples, at least a portion of flowchart 600 may be performed using one or more computing devices 1000 of FIG. 10. In the performance of the various branches, flowchart 600 is invoked twice. For the first invocation, after operation 520, flowchart 600 commences with an external caller initiating MT voice call 420 for UE 102, in operation 602, such as from UE 122. Wireless network 110 receives MT voice call 420 for UE 102 (i.e., receives signaling 412) in operation 604.

Based on at least receiving MT voice call 420, in decision operation 606, wireless network 110 determines whether UE 102 is currently registered. See messages 414 and 416 of message sequence diagram 400. If UE 102 is not currently registered, in some examples, MT voice call 420 is routed to both UE 102 and AE 104 as a forked call, in operation 610. This means that, if AE 104 answers MT voice call 420 in operation 612, signaling 412 of MT voice call 420 is terminated to UE 102 in operation 614; or if UE 102 answers MT voice call 420 in operation 616, signaling 412 of MT voice call 420 is terminated to AE 104 in operation 618. UE 102 answering MT voice call 420 may require UE 102 receiving paging 418 and registering with wireless network 110 using messages 426.

In other examples, MT voice call 420 is routed to both UE 102 and AE 104 as a multi-party call, in operation 620. This means that, even if AE 104 answers MT voice call 420 in operation 622, UE 102 is still able to answer and join MT voice call 420 in operation 624.

If, however, wireless network 110 determines that UE 102 is currently registered, in decision operation 606, MT voice call 420 is routed to UE 102 in operation 626, and UE 102 answers MT voice call 420 in operation 628. MT voice call 420 terminates in operation 630, and flowchart 600 concludes, returning to flowchart 500.

For the second invocation, after operation 536, flowchart 600 commences with an external caller initiating MT voice call 450 for UE 102, in operation 602, such as from UE 122. Wireless network 110 receives MT voice call 450 for UE 102 (i.e., receives signaling 442) in operation 604.

Based on at least receiving MT voice call 450, in decision operation 606, wireless network 110 determines whether UE 102 is currently registered. See messages 444 and 446 of message sequence diagram 430. If UE 102 is not currently registered, in some examples, MT voice call 450 is routed to both UE 102 and AE 104 as a forked call, in operation 610. This means that, if AE 104 answers MT voice call 450 in operation 612, signaling 442 of MT voice call 450 is terminated to UE 102 in operation 614; or if UE 102 answers MT voice call 450 in operation 616, signaling 442 of MT voice call 450 is terminated to AE 104 in operation 618. UE 102 answering MT voice call 450 may require UE 102 receiving paging 448 and registering with wireless network 110 using messages 456.

In other examples, MT voice call 450 is routed to both UE 102 and AE 104 as a multi-party call, in operation 620. This means that, even if AE 104 answers MT voice call 450 in operation 622, UE 102 is still able to answer and join MT voice call 450 in operation 624.

If, however, wireless network 110 determines that UE 102 is currently registered, in decision operation 606, MT voice call 450 is routed to UE 102 in operation 626, and UE 102 answers MT voice call 450 in operation 628. MT voice call 450 terminates in operation 630, and flowchart 600 concludes, returning to flowchart 500.

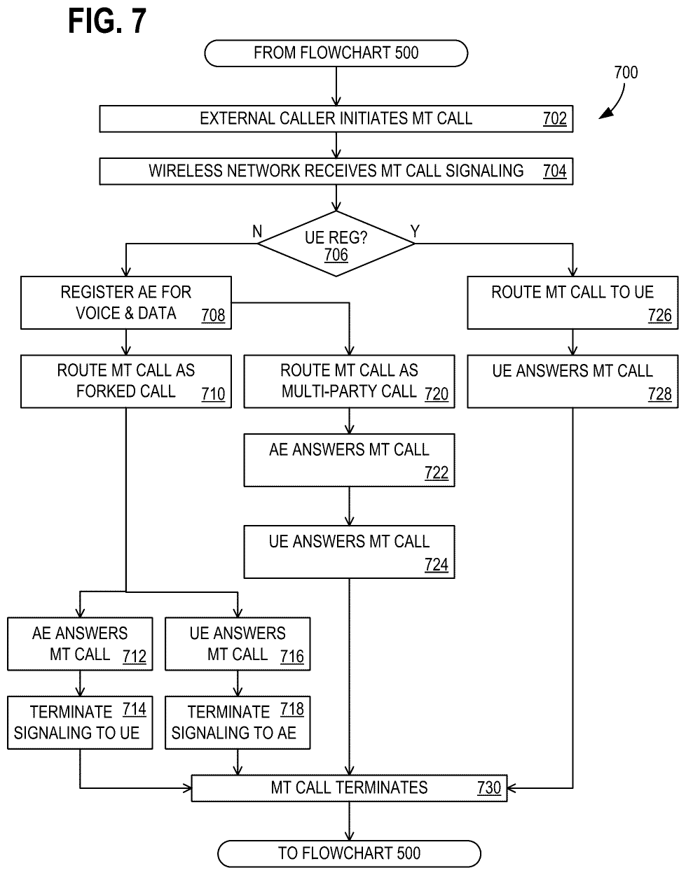

FIG. 7 illustrates a flowchart 700 of exemplary operations associated with receiving an MT call when AE 104 has a data only network connection. In some examples, at least a portion of flowchart 700 may be performed using one or more computing devices 1000 of FIG. 10. Flowchart 700 commences with an external caller initiating MT voice call 480 for UE 102, in operation 702, such as from UE 122. While AE 104 has a data only network connection, wireless network 110 receives MT voice call 480 for UE 102 (i.e., receives signaling 472) in operation 704.

Based on at least receiving MT voice call 480, in decision operation 706, wireless network 110 determines whether UE 102 is currently registered. See messages 474 and 476 of message sequence diagram 460. If UE 102 is not currently registered, operation 708 registers AE 104 for a voice and data network connection (as triggered by network core 428). See messages 478 of message sequence diagram 460.

In operation 710, MT voice call 480 is routed to both UE 102 and AE 104 as a forked call, in some examples. This means that, if AE 104 answers MT voice call 480 in operation 712, signaling 472 of MT voice call 480 is terminated to UE 102 in operation 714; or if UE 102 answers MT voice call 480 in operation 716, signaling 472 of MT voice call 480 is terminated to AE 104 in operation 718. UE 102 answering MT voice call 480 may require UE 102 receiving paging 482 and registering with wireless network 110 using messages 488.

In other examples, MT voice call 480 is routed to both UE 102 and AE 104 as a multi-party call, in operation 720. This means that, even if AE 104 answers MT voice call 480 in operation 722, UE 102 is still able to answer and join MT voice call 480 in operation 724.

If, however, wireless network 110 determines that UE 102 is currently registered, in decision operation 706, MT voice call 480 is routed to UE 102 in operation 726, and UE 102 answers MT voice call 480 in operation 728. MT voice call 480 terminates in operation 730, and flowchart 700 concludes, returning to flowchart 500.

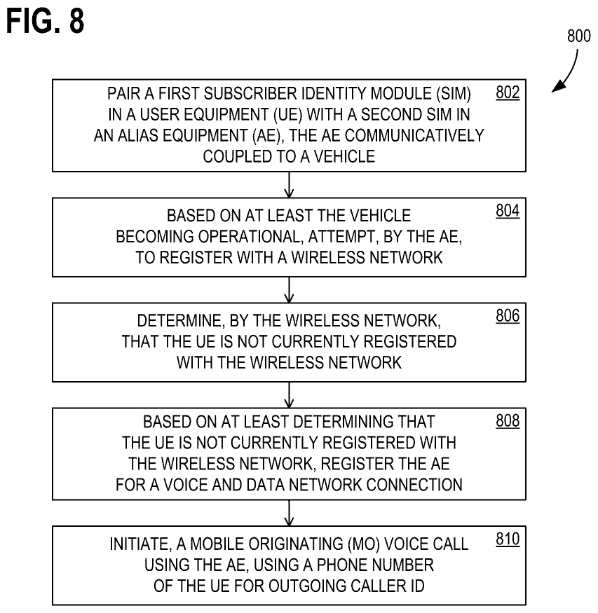

FIG. 8 illustrates a flowchart 800 of exemplary operations associated with architecture 100. In some examples, at least a portion of flowchart 800 may be performed using one or more computing devices 1000 of FIG. 10. Flowchart 800 commences with operation 802, which includes pairing a first SIM in UE with a second SIM in an AE, the AE communicatively coupled to a vehicle.

Operation 804 includes, based on at least the vehicle becoming operational, attempting, by the AE, to register with a wireless network. Operation 806 includes determining, by the wireless network, that the UE is not currently registered with the wireless network. Operation 808 includes, based on at least determining that the UE is not currently registered with the wireless network, registering the AE for a voice and data network connection. Operation 810 includes initiating, an MO voice call using the AE, using a phone number of the UE for outgoing caller ID.

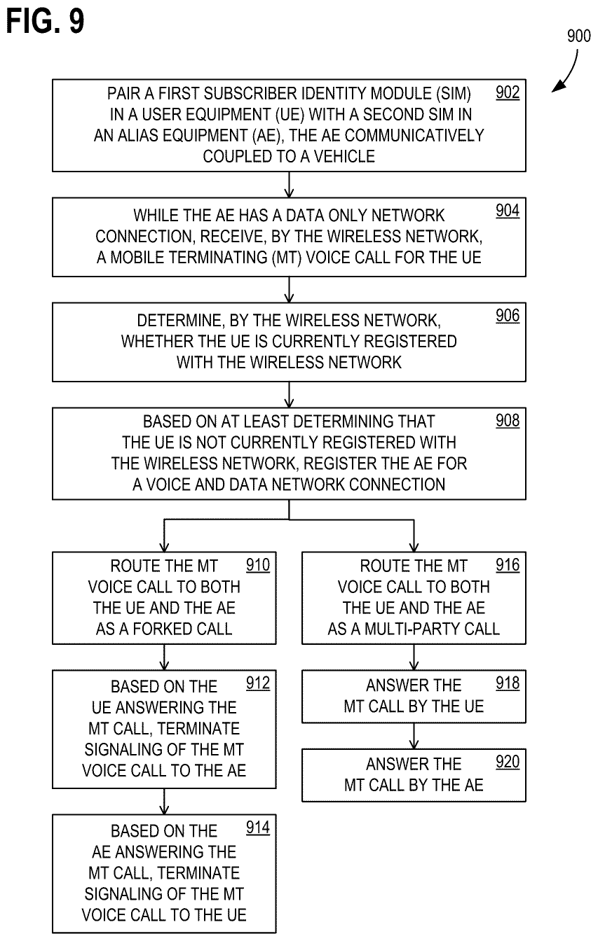

FIG. 9 illustrates a flowchart 900 of exemplary operations associated with architecture 100. In some examples, at least a portion of flowchart 900 may be performed using one or more computing devices 1000 of FIG. 10. Flowchart 900 commences with operation 902, which includes pairing a first SIM in a UE with a second SIM in an AE, the AE communicatively coupled to a vehicle. Operation 904 includes, while the AE has a data only network connection, receiving, by the wireless network, an MT voice call for the UE. Operation 906 includes determining, by the wireless network, whether the UE is currently registered with the wireless network.

Operation 908 includes, based on at least determining that the UE is not currently registered with the wireless network, registering the AE for a voice and data network connection. Flowchart 900 branches into either operations 910-914 or operations 916-920. Operation 910 includes routing the MT voice call to both the UE and the AE as a forked call. Operation 912 includes, based on the UE answering the MT voice call, terminating signaling of the MT voice call to the AE. Operation 914 includes, based on the AE answering the MT voice call, terminating signaling of the MT voice call to the UE. Operation 916 includes routing the MT voice call to both the UE and the AE as a multi-party call. Operation 918 includes answering the MT voice call by the UE. Operation 920 includes answering the MT voice call by the AE.

FIG. 10 illustrates a block diagram of computing device 1000 that may be used as any component described herein that may require computational or storage capacity. Computing device 1000 has at least a processor 1002 and a memory 1004 that holds program code 1010, data area 1020, and other logic and storage 1030. Memory 1004 is any device allowing information, such as computer executable instructions and/or other data, to be stored and retrieved. For example, memory 1004 may include one or more random access memory (RAM) modules, flash memory modules, hard disks, solid-state disks, persistent memory devices, and/or optical disks. Program code 1010 comprises computer executable instructions and computer executable components including instructions used to perform operations described herein. Data area 1020 holds data used to perform operations described herein. Memory 1004 also includes other logic and storage 1030 that performs or facilitates other functions disclosed herein or otherwise required of computing device 1000. An input/output (I/O) component 1040 facilitates receiving input from users and other devices and generating displays for users and outputs for other devices. A network interface 1050 permits communication over external network 1060 with a remote node 1070, which may represent another implementation of computing device 1000. For example, a remote node 1070 may represent another of the above-noted nodes within architecture 100.

### ADDITIONAL EXAMPLES

An example system comprises: a processor; and a computer-readable medium storing instructions that are operative upon execution by the processor to: pair a first SIM in a UE with a second SIM in an AE, the AE communicatively coupled to a vehicle; based on at least the vehicle becoming operational, attempt, by the AE, to register with a wireless network; determine, by the wireless network, that the UE is not currently registered with the wireless network; based on at least determining that the UE is not currently registered with the wireless network, register the AE for a voice and data network connection; and initiate, a first MO voice call using the AE, using a phone number of the UE for outgoing caller ID.

An example method of wireless communication comprises: pairing a first SIM in a UE with a second SIM in an AE, the AE communicatively coupled to a vehicle; based on at least the vehicle becoming operational, attempting, by the AE, to register with a wireless network; determining, by the wireless network, that the UE is not currently registered with the wireless network; based on at least determining that the UE is not currently registered with the wireless network, registering the AE for a voice and data network connection; and initiating, a first MO voice call using the AE, using a phone number of the UE for outgoing caller ID.

One or more example computer storage devices has computer-executable instructions stored thereon, which, upon execution by a computer, cause the computer to perform operations comprising: pairing a first SIM in a UE with a second SIM in an AE, the AE communicatively coupled to a vehicle; based on at least the vehicle becoming operational, attempting, by the AE, to register with a wireless network; determining, by the wireless network, that the UE is not currently registered with the wireless network; based on at least determining that the UE is not currently registered with the wireless network, registering the AE for a voice and data network connection; and initiating, a first MO voice call using the AE, using a phone number of the UE for outgoing caller ID.

Another example system comprises: a processor; and a computer-readable medium storing instructions that are operative upon execution by the processor to: pair a first SIM in a UE with a second SIM in an AE, the AE communicatively coupled to a vehicle; while the AE has a data only network connection, receive, by the wireless network, a third MT voice call for the UE; determine, by the wireless network, whether the UE is currently registered with the wireless network; based on at least determining that the UE is not currently registered with the wireless network, register the AE for a voice and data network connection; and either: route the third MT voice call to both the UE and the AE as a forked call; based on the UE answering the third MT voice call, terminate signaling of the third MT voice call to the AE; and based on the AE answering the third MT voice call, terminate signaling of the third MT voice call to the UE; or: route the third MT voice call to both the UE and the AE as a multi-party call.

Another example method of wireless communication comprises: pairing a first SIM in a UE with a second SIM in an AE, the AE communicatively coupled to a vehicle; while the AE has a data only network connection, receiving, by the wireless network, a third MT voice call for the UE; determining, by the wireless network, whether the UE is currently registered with the wireless network; based on at least determining that the UE is not currently registered with the wireless network, registering the AE for a voice and data network connection; and either: routing the third MT voice call to both the UE and the AE as a forked call; based on the UE answering the third MT voice call, terminating signaling of the third MT voice call to the AE; and based on the AE answering the third MT voice call, terminating signaling of the third MT voice call to the UE; or: routing the third MT voice call to both the UE and the AE as a multi-party call.

One or more additional example computer storage devices has computer-executable instructions stored thereon, which, upon execution by a computer, cause the computer to perform operations comprising: pairing a first SIM in a UE with a second SIM in an AE, the AE communicatively coupled to a vehicle; while the AE has a data only network connection, receiving, by the wireless network, a third MT voice call for the UE; determining, by the wireless network, whether the UE is currently registered with the wireless network; based on at least determining that the UE is not currently registered with the wireless network, registering the AE for a voice and data network connection; and either: routing the third MT voice call to both the UE and the AE as a forked call; based on the UE answering the third MT voice call, terminating signaling of the third MT voice call to the AE; and based on the AE answering the third MT voice call, terminating signaling of the third MT voice call to the UE; or: routing the third MT voice call to both the UE and the AE as a multi-party call.

Alternatively, or in addition to the other examples described herein, examples include any combination of the following:
the wireless network comprises a cellular network;
the UE comprises an eMBB or cellular telephone;
determining, by the wireless network, whether the UE is currently registered with the wireless network;
determining whether the UE is currently registered with the wireless network comprises determining whether the UE has had an active registration with the wireless network during a preceding defined time period;
while the AE has a voice and data network connection, receiving, by the wireless network, a first MT voice call for the UE;
based on at least determining that the UE is not currently registered with the wireless network, either: routing the first MT voice call to both the UE and the AE as a forked call; based on the UE answering the first MT voice call, terminating signaling of the first MT voice call to the AE; and based on the AE answering the first MT voice call, terminating signaling of the first MT voice call to the UE; or routing the first MT voice call to both the UE and the AE as a multi-party call; answering the first MT voice call by the UE; and answering the first MT voice call by the AE;
based on at least determining that the UE is currently registered with the wireless network, registering the AE for a data only network connection that does not include voice capability;
performing a voice connectivity authorization process for the AE;
the voice connectivity authorization process comprises: receiving, by the AE, an authorization code into the AE; and transmitting, by the AE, the authorization code to the wireless network;
based on at least performing the voice connectivity authorization process, registering the AE for a voice and data network connection;
initiating, a second MO voice call using the AE, using the phone number of the UE for outgoing caller ID;
while the AE has a voice and data network connection, receiving, by the wireless network, a second MT voice call for the UE;
based on at least determining that the UE is not currently registered with the wireless network, either: routing the second MT voice call to both the UE and the AE as a forked call; based on the UE answering the second MT voice call, terminating signaling of the second MT voice call to the AE; and based on the AE answering the second MT voice call, terminating signaling of the second MT voice call to the UE; or routing the second MT voice call to both the UE and the AE as a multi-party call; answering the second MT voice call by the UE; and answering the second MT voice call by the AE;
based on at least both the UE and the AE each being registered for a voice and data network connection, upon lapse of a timer or a request from the AE, moving registration of the AE to a data only network connection that does not include voice capability;
while the AE has a data only network connection, receiving, by the wireless network, a third MT voice call for the UE;
based on at least determining that the UE is not currently registered with the wireless network, registering the AE for a voice and data network connection;
routing the third MT voice call to both the UE and the AE as a forked call; based on the UE answering the third MT voice call, terminating signaling of the third MT voice call to the AE; and based on the AE answering the third MT voice call, terminating signaling of the third MT voice call to the UE;
routing the third MT voice call to both the UE and the AE as a multi-party call; answering the third MT voice call by the UE; and answering the third MT voice call by the AE;
the first SIM and the second SIM are each associated with a user account of an account holder;
the first SIM and the second SIM each comprises a pSIM or an eSIM;
the first SIM and the second SIM are each voice capable;
communicatively coupling the AE to the vehicle;
the AE either has a microphone and a speaker for voice calls or is communicatively coupled to a microphone and a speaker of the vehicle;
the AE either has a keypad or a touchscreen for data entry or is communicatively coupled to a keypad or a touchscreen of the vehicle;
the preceding defined time period is five minutes;
registering the AE for a voice and data network connection comprises registering the AE for IMS connectivity;
registering the AE for a data only network connection results in not registering the AE for IMS connectivity;
receiving the authorization code into the AE using the keypad of the AE, the touchscreen of the AE, the keypad of the vehicle, or the touchscreen of the vehicle;
the authorization code comprises a USSD PIN;
the authorization code comprises a voicemail PIN or password; and
based on at least the vehicle becoming non-operational, deregistering the AE from the wireless network.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
pairing a first subscriber identity module (SIM) in a user equipment (UE) with a second SIM in an alias equipment (AE), the AE communicatively coupled to a vehicle;
based on at least the vehicle becoming operational, attempting, by the AE, to register with a wireless network;
determining, by the wireless network, that the UE is not currently registered with the wireless network;
based on at least determining that the UE is not currently registered with the wireless network, registering the AE for a voice and data network connection; and
initiating, a first mobile originating (MO) voice call using the AE, using a phone number of the UE for outgoing caller ID.

2. The method of claim 1, further comprising:
while the AE has a voice and data network connection, receiving, by the wireless network, a first mobile terminating (MT) voice call for the UE;
determining, by the wireless network, whether the UE is currently registered with the wireless network; and
based on at least determining that the UE is not currently registered with the wireless network, either:
routing the first MT voice call to both the UE and the AE as a forked call;
based on the UE answering the first MT voice call, terminating signaling of the first MT voice call to the AE; and
based on the AE answering the first MT voice call, terminating signaling of the first MT voice call to the UE;
or:
routing the first MT voice call to both the UE and the AE as a multi-party call.

3. The method of claim 1, further comprising:
determining, by the wireless network, whether the UE is currently registered with the wireless network, wherein determining whether the UE is currently registered with the wireless network comprises determining whether the UE has had an active registration with the wireless network during a preceding defined time period; and
based on at least determining that the UE is currently registered with the wireless network, registering the AE for a data only network connection that does not include voice capability.

4. The method of claim 3, further comprising:
performing a voice connectivity authorization process for the AE;
based on at least performing the voice connectivity authorization process, registering the AE for a voice and data network connection; and
initiating, a second MO voice call using the AE, using the phone number of the UE for outgoing caller ID.

5. The method of claim 4, wherein the voice connectivity authorization process comprises:
receiving, by the AE, an authorization code into the AE; and
transmitting, by the AE, the authorization code to the wireless network.

6. The method of claim 4, further comprising:
while the AE has a voice and data network connection, receiving, by the wireless network, a second mobile terminating (MT) voice call for the UE;
determining, by the wireless network, whether the UE is currently registered with the wireless network; and
based on at least determining that the UE is not currently registered with the wireless network, either:
routing the second MT voice call to both the UE and the AE as a forked call;
based on the UE answering the second MT voice call, terminating signaling of the second MT voice call to the AE; and
based on the AE answering the second MT voice call, terminating signaling of the second MT voice call to the UE;
or:
routing the second MT voice call to both the UE and the AE as a multi-party call.

7. The method of claim 4, further comprising:
based on at least both the UE and the AE each being registered for a voice and data network connection, upon lapse of a timer or a request from the AE, moving registration of the AE to a data only network connection that does not include voice capability.

8. The method of claim 3, further comprising:
while the AE has a data only network connection, receiving, by the wireless network, a third mobile terminating (MT) voice call for the UE;
determining, by the wireless network, whether the UE is currently registered with the wireless network;
based on at least determining that the UE is not currently registered with the wireless network, registering the AE for a voice and data network connection; and
either:
routing the third MT voice call to both the UE and the AE as a forked call;
based on the UE answering the third MT voice call, terminating signaling of the third MT voice call to the AE; and
based on the AE answering the third MT voice call, terminating signaling of the third MT voice call to the UE;
or:
routing the third MT voice call to both the UE and the AE as a multi-party call.

9. A system comprising:
a processor; and
a computer-readable medium storing instructions that are operative upon execution by the processor to:
pair a first subscriber identity module (SIM) in a user equipment (UE) with a second SIM in an alias equipment (AE), the AE communicatively coupled to a vehicle;
based on at least the vehicle becoming operational, attempt, by the AE, to register with a wireless network;
determine, by the wireless network, that the UE is not currently registered with the wireless network;
based on at least determining that the UE is not currently registered with the wireless network, register the AE for a voice and data network connection; and
initiate, a first mobile originating (MO) voice call using the AE, using a phone number of the UE for outgoing caller ID.

10. The system of claim 9, wherein the instructions are further operative to:
while the AE has a voice and data network connection, receive, by the wireless network, a first mobile terminating (MT) voice call for the UE;
determine, by the wireless network, whether the UE is currently registered with the wireless network; and
based on at least determining that the UE is not currently registered with the wireless network, either:
route the first MT voice call to both the UE and the AE as a forked call;
based on the UE answering the first MT voice call, terminate signaling of the first MT voice call to the AE; and
based on the AE answering the first MT voice call, terminate signaling of the first MT voice call to the UE;
or
route the first MT voice call to both the UE and the AE as a multi-party call.

11. The system of claim 9, wherein the instructions are further operative to:
determine, by the wireless network, whether the UE is currently registered with the wireless network, wherein determining whether the UE is currently registered with the wireless network comprises determining whether the UE has had an active registration with the wireless network during a preceding defined time period; and
based on at least determining that the UE is currently registered with the wireless network, register the AE for a data only network connection that does not include voice capability.

12. The system of claim 11, wherein the instructions are further operative to:
perform a voice connectivity authorization process for the AE;
based on at least performing the voice connectivity authorization process, register the AE for a voice and data network connection; and
initiate, a second MO voice call using the AE, using the phone number of the UE for outgoing caller ID.

13. The system of claim 12, the voice connectivity authorization process comprises:
receiving, by the AE, an authorization code into the AE; and
transmitting, by the AE, the authorization code to the wireless network.

14. The system of claim 12, wherein the instructions are further operative to:
while the AE has a voice and data network connection, receive, by the wireless network, a second mobile terminating (MT) voice call for the UE;
determine, by the wireless network, whether the UE is currently registered with the wireless network; and
based on at least determining that the UE is not currently registered with the wireless network, either:
route the second MT voice call to both the UE and the AE as a forked call;
based on the UE answering the second MT voice call, terminate signaling of the second MT voice call to the AE; and
based on the AE answering the second MT voice call, terminate signaling of the second MT voice call to the UE;
or
route the second MT voice call to both the UE and the AE as a multi-party call.

15. The system of claim 12, wherein the instructions are further operative to:
based on at least both the UE and the AE each being registered for a voice and data network connection, upon lapse of a timer or a request from the AE, moving registration of the AE to a data only network connection that does not include voice capability.

16. The system of claim 11, wherein the instructions are further operative to:
while the AE has a data only network connection, receive, by the wireless network, a third mobile terminating (MT) voice call for the UE;
determine, by the wireless network, whether the UE is currently registered with the wireless network;
based on at least determining that the UE is not currently registered with the wireless network, register the AE for a voice and data network connection; and
either:
route the third MT voice call to both the UE and the AE as a forked call;
based on the UE answering the third MT voice call, terminate signaling of the third MT voice call to the AE; and
based on the AE answering the third MT voice call, terminate signaling of the third MT voice call to the UE;
or
route the third MT voice call to both the UE and the AE as a multi-party call.

17. One or more computer storage devices having computer-executable instructions stored thereon, which, upon execution by a computer, cause the computer to perform operations comprising:
pairing a first subscriber identity module (SIM) in a user equipment (UE) with a second SIM in an alias equipment (AE), the AE communicatively coupled to a vehicle;
based on at least the vehicle becoming operational, attempting, by the AE, to register with a wireless network;
determining, by the wireless network, that the UE is not currently registered with the wireless network;
based on at least determining that the UE is not currently registered with the wireless network, registering the AE for a voice and data network connection; and
initiating, a first mobile originating (MO) voice call using the AE, using a phone number of the UE for outgoing caller ID.

18. The one or more computer storage devices of claim 17, wherein the operations further comprise:
while the AE has a voice and data network connection, receiving, by the wireless network, a first mobile terminating (MT) voice call for the UE;
determining, by the wireless network, whether the UE is currently registered with the wireless network; and
based on at least determining that the UE is not currently registered with the wireless network, either:
routing the first MT voice call to both the UE and the AE as a forked call;
based on the UE answering the first MT voice call, terminating signaling of the first MT voice call to the AE; and
based on the AE answering the first MT voice call, terminating signaling of the first MT voice call to the UE;
or
routing the first MT voice call to both the UE and the AE as a multi-party call.

19. The one or more computer storage devices of claim 17, wherein the operations further comprise:
determining, by the wireless network, whether the UE is currently registered with the wireless network, wherein determining whether the UE is currently registered with the wireless network comprises determining whether the UE has had an active registration with the wireless network during a preceding defined time period; and
based on at least determining that the UE is currently registered with the wireless network, registering the AE for a data only network connection that does not include voice capability.

20. The one or more computer storage devices of claim 19, wherein the operations further comprise:
while the AE has a data only network connection, receiving, by the wireless network, a third mobile terminating (MT) voice call for the UE;
determining, by the wireless network, whether the UE is currently registered with the wireless network;
based on at least determining that the UE is not currently registered with the wireless network, registering the AE for a voice and data network connection; and
either:
routing the third MT voice call to both the UE and the AE as a forked call;
based on the UE answering the third MT voice call, terminating signaling of the third MT voice call to the AE; and
based on the AE answering the third MT voice call, terminating signaling of the third MT voice call to the UE;
or
routing the third MT voice call to both the UE and the AE as a multi-party call.
